(19) United States
(12) Patent Application Publication
(10) Pub. No.: US 2022/0020974 A1
(43) Pub. Date: Jan. 20, 2022

(54) BATTERY SEPARATORS COMPRISING HYBRID SOLID STATE ELECTROLYTE COATINGS

(71) Applicant: GM GLOBAL TECHNOLOGY OPERATIONS LLC, Detroit, MI (US)

(72) Inventors: Thomas A. Yersak, Royal Oak (US); Fan Xu, Oakland Township, MI (US); Robert D. Schmidt, Howell, MI (US); Biqiong Wang, Madison Heights, MI (US)

(21) Appl. No.: 16/928,052

(22) Filed: Jul. 14, 2020

(51) Int. Cl. H01M 2/16; H01M 4/62; H01M 10/0525; H01M 4/505; H01M 4/525; H01M 4/58

(52) U.S. Cl. CPC H01M 2/1653; H01M 4/623; H01M 10/0525; H01M 4/5825; H01M 4/505; H01M 4/525; H01M 2/1673

(57) ABSTRACT

A separator includes a porous polymeric separator having an anode side and a cathode side, a cathode-compatible material applied to the cathode side, wherein the cathode-compatible material comprises a polymeric binder and one or more of lithium aluminum titanium phosphate (LATP) particles, lithium lanthanum titanate (LLTO) particles, lithium aluminum germanium phosphate (LAGP) particles, and lithium superionic conductor (LISICON) particles, and an anode-compatible material applied to the anode side, wherein the anode-compatible material comprises lithium lanthanum zirconium oxide (LLZO) particles and a polymeric binder. The polymeric binder of the cathode-compatible material can be polyvinylidene fluoride and the polymeric binder of the anode-compatible material can be polyvinylidene. The polymeric binder of the cathode-compatible material the anode-compatible material can be the polymeric separator. The LLZO particles and the one or more of LATP, LLTO, LAGP, and LISICON particles can have an average particle size of 10 nm to 10 μm.

### INTRODUCTION

Lithium ion batteries describe a class of rechargeable batteries in which lithium ions move between a negative electrode (i.e., anode) and a positive electrode (i.e., cathode). Liquid, solid, and polymer electrolytes can facilitate the movement of lithium ions between the anode and cathode. Lithium ion batteries further include a porous separator disposed between the anode and the cathode capable of facilitating the movement of lithium ions throughout the electrode. Such separators commonly include a polymeric body with an inert ceramic coating. Lithium ion batteries are growing in popularity for defense, automotive, and aerospace applications due to their high energy density and ability to undergo successive charge and discharge cycles.

### SUMMARY

Provided are separators for lithium-ion batteries, which can include a porous polymeric separator body having an anode side and a cathode side, a cathode-compatible material applied to the cathode side, and an anode-compatible material applied to the anode side. The cathode-compatible material can include a polymeric binder and one or more of lithium aluminum titanium phosphate (LATP) particles, lithium lanthanum titanate (LLTO) particles, lithium aluminum germanium phosphate (LAGP) particles, and lithium supertonic conductor (LISICON) particles. The anode-compatible material can include lithium lanthanum zirconium oxide (LLZO) particles and a polymeric binder. The polymeric binder of the cathode-compatible material can be polyvinylidene fluoride (PVDF). The polymeric binder of the anode-compatible material can be polyvinylpyrrolidone (PVP). The polymeric binder of the cathode-compatible material comprises the polymeric separator and the polymeric binder of the anode-compatible material comprises the polymeric separator. The separator of claim 1, wherein the cathode-compatible material and the anode-compatible material each can have at most 30 wt. % polymeric binder. The LLZO particles and the one or more of LATP particles, LLTO particles, LAGP particles, and LISICON particles can each have an average particle size of about 10 nm to about 10 μm. The cathode-compatible material and the anode-compatible material each can have a thickness of about 100 nm to about 20 μm. The separator body can include one or more of polyethylene and polypropylene. The separator body can have an average porosity of about 30% to 70%. The separator body can have a thickness of about 7 μm to 19 μm.

Provided are lithium battery cells which can include an electrolyte, an anode disposed within the electrolyte, a cathode disposed within the electrolyte, and a separator disposed within the electrolyte between the anode and the cathode. The separator can include a porous polymeric separator body having an anode side and a cathode side, a cathode-compatible material applied to the cathode side, and an anode-compatible material applied to the anode side. The cathode-compatible material can include a polymeric binder and one or more of lithium aluminum titanium phosphate (LATP) particles, lithium lanthanum titanate (LLTO) particles, lithium aluminum germanium phosphate (LAGP) particles, and lithium supertonic conductor (LISICON) particles. The anode-compatible material can include lithium lanthanum zirconium oxide (LLZO) particles and a polymeric binder. The polymeric binder of the cathode-compatible material can include polyvinylidene fluoride (PVDF) and the polymeric binder of the anode-compatible material can include polyvinylpyrrolidone (PVP). The electrolyte can be a liquid electrolyte. The cathode-compatible material and the anode-compatible material each can have at most 30 wt. % polymeric binder. The LLZO particles and the one or more of LATP particles, LLTO particles, LAGP particles, and LISICON particles each can have an average particle size of about 10 nm to about 10 μm. The cathode-compatible material and the anode-compatible material each can have a thickness of about 100 nm to about 20 μm. The cathode can include a lithium iron phosphate active material. The cathode can include a LiNiₓCo_{y}Mn_{z}O₂ active material, wherein 0.33<x<0.85, 0.05<y<0.33, 0.05<z<0.33, and x+y+z=1. The cathode can include a Li_{1.2}Mn_{0.525}Ni_{0.175}Co_{0.1}O₂ active material. The cathode can include a LiNiₐCo_{b}Mn_{c}Al_{d}O₂ active material, wherein wherein 0.33<a<0.9, 0.05<b<0.33, 0.05<c<0.33, 0.01<d<0.02, a+b+c+d=1.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a lithium battery cell, according to one or more embodiments;

FIG. 2 illustrates a schematic diagram of a hybrid-electric vehicle, according to one or more embodiments; and

FIG. 3 illustrates a schematic side view of a separator for a lithium ion battery, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

While conventional battery separators utilizing inert ceramic coatings provide acceptable mechanical and electrical insulation, the inert ceramic coatings cannot chemically conduct lithium ions. Therefore, lithium ions are conducted through the separator via physical pores only, thereby increasing tortuosity. Provided herein are battery separators with hybrid solid state electrolyte (SSE) coatings to provide enhanced ion mobility and cell stability.

FIG. 1 illustrates a lithium battery cell 10 comprising a negative electrode (i.e., the anode) 11, a positive electrode (i.e., the cathode) 14, an electrolyte 17 operatively disposed between the Anode 11 and the cathode 14, and a separator 18. Anode 11, cathode 14, and electrolyte 17 can be encapsulated in container 19, which can be a hard (e.g., metallic) case or soft (e.g., polymer) pouch, for example. The Anode 11 and cathode 14 are situated on opposite sides of separator 18 which can comprise a microporous polymer or other suitable material capable of conducting lithium ions and optionally electrolyte (i.e., liquid electrolyte). Electrolyte 17 is a liquid electrolyte comprising one or more lithium salts dissolved in a non-aqueous solvent. Anode 11 generally includes a current collector 12 and a lithium intercalation host material 13 applied thereto. Cathode 14 generally includes a current collector 15 and a lithium-based active material 16 applied thereto. For example, the battery cell 10 can comprise a lithium metal oxide active material 16, among many others, as will be described below. Active material 16 can store lithium ions at a higher electric potential than intercalation host material 13, for example. The current collectors 12 and 15 associated with the two electrodes are connected by an interruptible external circuit that allows an electric current to pass between the electrodes to electrically balance the related migration of lithium ions. Although FIG. 1 illustrates host material 13 and active material 16 schematically for the sake of clarity, host material 13 and active material 16 can comprise an exclusive interface between the anode 11 and cathode 14, respectively, and electrolyte 17.

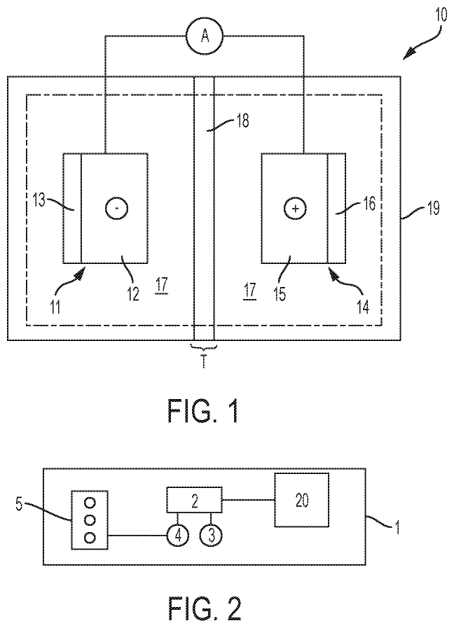

Battery cell 10 can be used in any number of applications. For example, FIG. 2 illustrates a schematic diagram of a hybrid-electric vehicle 1 including a battery pack 20 and related components. A battery pack such as the battery pack 20 can include a plurality of battery cells 10. A plurality of battery cells 10 can be connected in parallel to form a group, and a plurality of groups can be connected in series, for example. One of skill in the art will understand that any number of battery cell connection configurations are practicable utilizing the battery cell architectures herein disclosed, and will further recognize that vehicular applications are not limited to the vehicle architecture as described. Battery pack 20 can provide energy to a traction inverter 2 which converts the direct current (DC) battery voltage to a three-phase alternating current (AC) signal which is used by a drive motor 3 to propel the vehicle 1. An engine 5 can be used to drive a generator 4, which in turn can provide energy to recharge the battery pack 20 via the inverter 2. External (e.g., grid) power can also be used to recharge the battery pack 20 via additional circuitry (not shown). Engine 5 can comprise a gasoline or diesel engine, for example.

Battery cell 10 generally operates by reversibly passing lithium ions between Anode 11 and cathode 14. Lithium ions move from cathode 14 to Anode 11 while charging, and move from Anode 11 to cathode 14 while discharging. At the beginning of a discharge, Anode 11 contains a high concentration of intercalated/alloyed lithium ions while cathode 14 is relatively depleted, and establishing a closed external circuit between Anode 11 and cathode 14 under such circumstances causes intercalated/alloyed lithium ions to be extracted from Anode 11. The extracted lithium atoms are split into lithium ions and electrons as they leave an intercalation/alloying host at an electrode-electrolyte interface. The lithium ions are carried through the micropores of separator 18 from Anode 11 to cathode 14 by the ionically conductive electrolyte 17 while, at the same time, the electrons are transmitted through the external circuit from Anode 11 to cathode 14 to balance the overall electrochemical cell. This flow of electrons through the external circuit can be harnessed and fed to a load device until the level of intercalated/alloyed lithium in the negative electrode falls below a workable level or the need for power ceases.

Battery cell 10 may be recharged after a partial or full discharge of its available capacity. To charge or re-power the lithium ion battery cell, an external power source (not shown) is connected to the positive and the negative electrodes to drive the reverse of battery discharge electrochemical reactions. That is, during charging, the external power source extracts the lithium ions present in cathode 14 to produce lithium ions and electrons. The lithium ions are carried back through the separator by the electrolyte solution, and the electrons are driven back through the external circuit, both towards Anode 11. The lithium ions and electrons are ultimately reunited at the negative electrode, thus replenishing it with intercalated/alloyed lithium for future battery cell discharge.

Lithium ion battery cell 10, or a battery module or pack comprising a plurality of battery cells 10 connected in series and/or in parallel, can be utilized to reversibly supply power and energy to an associated load device. Lithium ion batteries may also be used in various consumer electronic devices (e.g., laptop computers, cameras, and cellular/smart phones), military electronics (e.g., radios, mine detectors, and thermal weapons), aircrafts, and satellites, among others. Lithium ion batteries, modules, and packs may be incorporated in a vehicle such as a hybrid electric vehicle (HEV), a battery electric vehicle (BEV), a plug-in HEV, or an extended-range electric vehicle (EREV) to generate enough power and energy to operate one or more systems of the vehicle. For instance, the battery cells, modules, and packs may be used in combination with a gasoline or diesel internal combustion engine to propel the vehicle (such as in hybrid electric vehicles), or may be used alone to propel the vehicle (such as in battery powered vehicles).

Returning to FIG. 1, electrolyte 17 conducts lithium ions between anode 11 and cathode 14, for example during charging or discharging the battery cell 10. The electrolyte 17 comprises one or more solvents, and one or more lithium salts dissolved in the one or more solvents. Suitable solvents can include cyclic carbonates (ethylene carbonate, propylene carbonate, butylene carbonate), acyclic carbonates (dimethyl carbonate, diethyl carbonate, ethylmethylcarbonate), aliphatic carboxylic esters (methyl formate, methyl acetate, methyl propionate), γ-lactones (γ-butyrolactone, γ-valerolactone), chain structure ethers (1,3-dimethoxypropane, 1,2-dimethoxyethane (DME), 1-2-diethoxyethane, ethoxymethoxyethane), cyclic ethers (tetrahydrofuran, 2-methyltetrahydrofuran, 1,3-dioxolane), and combinations thereof. A non-limiting list of lithium salts that can be dissolved in the organic solvent(s) to form the non-aqueous liquid electrolyte solution include LiClO₄, LiAlCl₄, LiI, LiBr, LiSCN, LiBF₄, LiB(C₆H₅)₄ LiAsF₆, LiCF₃SO₃, LiN(CF₃SO₂)₂, LiN(FSO₂)₂, LiPF₆, and mixtures thereof.

A liquid electrolyte 17 can be a gel electrolyte, in some embodiments. Gel electrolytes 17 allows lithium ions to travel through the gel electrolyte 17 without the gel electrolyte 17 flowing in and out of one or more of the active material 16 and the host material 13. Generally, gel electrolytes have a high viscosity (e.g., about 10 mPa S to about 10,000 mPa S) which is high enough to prevent the gel electrolyte from flowing in and out of one or more of the active material 16 and the host material 13 yet low enough such that transport of lithium ions through the gel electrolyte 17 is not inhibited. In a particular example, a gel electrolyte can include one or more fluorinated monomers, one or more lithium salts, and one or more solvents, among others known in the art. Active material 16 can include any lithium-based active material that can sufficiently undergo lithium intercalation and deintercalation while functioning as the positive terminal of battery cell 10. Active material 16 can also include a polymer binder material to structurally hold the lithium-based active material together. The active material 16 can comprise lithium transition metal oxides described below. Cathode current collector 15 can include aluminum or any other appropriate electrically conductive material known to skilled artisans, and can be formed in a foil or grid shape. Cathode current collector 15 can be treated (e.g., coated) with highly electrically conductive materials, including one or more of conductive carbon black, graphite, carbon nanotubes, carbon nanofiber, graphene, and vapor growth carbon fiber (VGCF), among others. The same highly electrically conductive materials can additionally or alternatively be dispersed within the host material 13.

Lithium transition metal oxides suitable for use as active material 16 can comprise one or more of spinel lithium manganese oxide (LiMn₂O₄), lithium cobalt oxide (LiCoO₂), a nickel-manganese oxide spinel (Li(Nio₅Mn_{1.5})O₂), a layered nickel-manganese-cobalt oxide (having a general formula of xLi₂MnO₃.(1−x)LiMO₂, where M is composed of any ratio of Ni, Mn and/or Co).

A specific example of the layered nickel-manganese oxide spinel is xLi₂MnO₃.(1−x)Li(Ni_{1/3}Mn_{1/3}Co_{1/3})O₂. Other suitable lithium-based active materials include Li(Ni_{1/3}Mn_{1/3}Co_{1/3})O₂), LiNiO₂, Li_{x+y}Mn_{2-y}O₄ (LMO, 0<x<1 and 0<y<0.1), or a lithium iron polyanion oxide, such as lithium iron phosphate (LiFePO₄, LiMn₁₋ₓFeₓPO₄) or lithium iron fluorophosphate (Li₂FePO₄F). Other lithium-based active materials may also be utilized, such as LiNiₓM₁₋ₓO₂ (M is composed of any ratio of Al, Co, and/or Mg), LiNi₁₋ₓCo_{1-y}Mn_{x+y}O₂ or LiMn_{1.5-x}Ni_{0.5-y}M_{x+y}O₄ (M is composed of any ratio of Al, Ti, Cr, and/or Mg), stabilized lithium manganese oxide spinel (LiₓMn_{2-y}M_{y}O₄, where M is composed of any ratio of Al, Ti, Cr, and/or Mg), lithium nickel cobalt aluminum oxide (e.g., LiNi_{0.8}Co_{0.15}Al_{0.05}O₂ or NCA), aluminum stabilized lithium manganese oxide spinel (LixMn₂₋ₓAl_{y}O₄), lithium vanadium oxide (LiV₂O₅), Li₂MSiO₄ (M is composed of any ratio of Co, Fe, and/or Mn), and any other high efficiency nickel-manganese-cobalt material. By “any ratio” it is meant that any element may be present in any amount. So, for example, M could be Al, with or without Co and/or Mg, or any other combination of the listed elements. In another example, anion substitutions may be made in the lattice of any example of the lithium transition metal based active material to stabilize the crystal structure. For example, any O atom may be substituted with an F atom.

In particular, suitable active materials 16 include lithium iron phosphate, NMC, NCMA, and HE-NMC materials. NMC active materials 16 can include materials defined by the formula LiNiₓCo_{y}Mn_{z}O₂, wherein 0.33<x<0.85, 0.05<y<0.33, 0.05<z<0.33, and x+y+z=1 (e.g., LiNi_{0.8}Co_{0.1}Mn_{0.1}O₂ (NMC811), LiNi_{0.6}Mn_{0.2}Co_{0.2}O₂ (NMC622)). NCMA active materials 16 can include materials defined by the formula LiNiₐCo_{b}Mn_{c}Al_{d}O₂, wherein 0.33<a<0.9, 0.05<b<0.33, 0.05<c<0.33, 0.01<d<0.02, and a+b+c+d=1 (e.g., Li[Ni_{0.89}Co_{0.05}Mn_{0.05}Al_{0.01}]O₂). HE-NMC active materials 16 can include Li_{1.2}Mn_{0.525}Ni_{0.175}Co_{0.1}O₂, among other high-energy NMC materials.

The anode current collector 12 can include copper, aluminum, stainless steel, or any other appropriate electrically conductive material known to skilled artisans. Anode current collector 12 can be treated (e.g., coated) with highly electrically conductive materials, including one or more of conductive carbon black, graphite, carbon nanotubes, carbon nanofiber, graphene, and vapor growth carbon fiber (VGCF), among others. The host material 13 applied to the anode current collector 12 can include any lithium host material that can sufficiently undergo lithium ion intercalation, deintercalation, and alloying, while functioning as the negative terminal of the lithium ion battery 10. Host material 13 can optionally further include a polymer binder material to structurally hold the lithium host material together. For example, in one embodiment, host material 13 can further include a carbonaceous material (e.g., graphite) and/or one or more of binders (e.g., polyvinylidene fluoride (PVdF), an ethylene propylene diene monomer (EPDM) rubber, carboxymethoxyl cellulose (CMC), and styrene, 1,3-butadiene polymer (SBR)).

The microporous polymer separator 18 can comprise, in one embodiment, a polyolefin. The polyolefin can be a homopolymer (derived from a single monomer constituent) or a heteropolymer (derived from more than one monomer constituent), either linear or branched. If a heteropolymer derived from two monomer constituents is employed, the polyolefin can assume any copolymer chain arrangement including those of a block copolymer or a random copolymer. The same holds true if the polyolefin is a heteropolymer derived from more than two monomer constituents. In one embodiment, the polyolefin can be polyethylene (PE), polypropylene (PP), or a blend of PE and PP. The microporous polymer separator 18 may also comprise other polymers in addition to the polyolefin such as, but not limited to, polyethylene terephthalate (PET), polyvinylidene fluoride (PVdF), and or a polyamide (Nylon). In some embodiments, the separator 18 can have a porosity of about 30% to about 70%, about 35% to about 65%, about 40% to about 60% or about 50%, in some endowments. In some embodiments, the separator 18 can have a thickness T of about 7 μm to 19 μm, about 8 μm to about 17 μm, or about 16 μm.

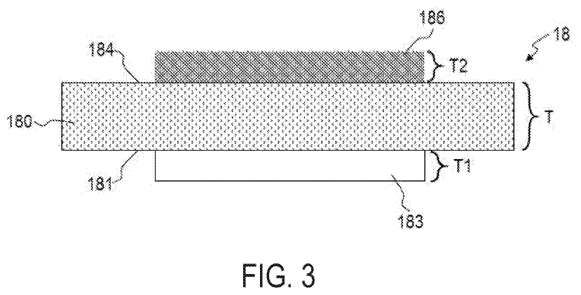

Separator 18, as illustrated in FIG. 3 comprises a porous body 180, as described above, defining an anode side 181 surface and a cathode side 184 surface. Separator 18 as will be described is suitable for incorporation into lithium battery cell 10. Separator 18 further comprises a cathode-compatible material 186 applied to the cathode side 184 and an anode-compatible material 183 applied to the anode side 181. It is to be understood that FIG. 3 provides a schematic depiction of separator 18, and the same is not meant to be limited thereby. In particular, the cathode-compatible material 186 can applied to the entire cathode side 184, or all portions of the cathode side 184 which interface with electrolyte 17. Similarly, the anode-compatible material 183 can be applied to the entire anode side 181, or all portions of the anode side 181 which interface with electrolyte 17. Each of the cathode anode-compatible material 183 and the cathode-compatible material 186 comprise SSE particles, and the SSE particles in the anode-compatible material 183 are different from the SEE particles in the cathode-compatible material 186.

The cathode-compatible material 186 comprises a polymeric binder and one or more of lithium aluminum titanium phosphate (e.g., Li_{1.3}Al_{0.3}Ti_{1.7}(PO₄)₃) (LATP) particles, lithium lanthanum titanate (e.g., Li_{0.67-x}La₃ₓTiO₃) (LLTO) particles, lithium aluminum germanium phosphate (e.g., Li₁₊ₓAlₓGe₂₋ₓ(PO₄)₃) (LAGP) particles, and lithium superionic conductor (e.g., Li₁₄Zn(GeO₄)₄ and/or Li₃₊ₓ(P₁₋ₓSiₓ)O₄) (LISICON) particles. The anode-compatible material comprises lithium lanthanum zirconium oxide (e.g., Li₇La₃Zr₂O₁₂) (LLZO) particles and a polymeric binder. The polymeric binders of the cathode-compatible material 186 and the anode-compatible material 181 structurally bind the one or more of LATP particles, LLTO particles, LAGP particles, and LISICON particles, and LLZO particles to the separator. Such binders can include polyvinyldiene fluoride (PVDF), polyvinylidene fluoride-co-hexafluoropropylene (PVDF-HFP), nitrile butadiene rubbers (NBR), polyacrylonitrile (PAN), polyvinylpyrrolidone (PVP), polyethylene oxide (PEO), an ethylene propylene diene monomer (EPDM) rubber, carboxymethoxyl cellulose (CMC), lithium polyacrylate (LiPAA), sodium polyacrylate (NaPAA), sodium alginate, lithium alginate, and styrene, 1,3-butadiene polymer (SBR)). The polymeric binders of the cathode-compatible material 186 and the anode-compatible material 181 are particularly selected due to their stability while proximate the cathode 14 and anode 11, respectively. For example, LLZO reacts with PVDF, PVDF-HFP, and PAN.

In some embodiments, the polymeric binder of the cathode-compatible material 186 comprises PVDF. In other embodiments, the polymeric binder of the cathode-compatible material 186 consists of PVDF. In some embodiments, the polymeric binder of the anode-compatible material 181 comprises PVP. In other embodiments, the polymeric binder of the anode-compatible material 181 consists of PVP. In some embodiments, the polymeric binder of the cathode-compatible material 186 comprises PVDF and the polymeric binder of the anode-compatible material 181 comprises PVP. In other embodiments, the polymeric binder of the cathode-compatible material 186 consists of PVDF and the polymeric binder of the anode-compatible material 181 consists of PVP.

The cathode-compatible material 186 and the anode-compatible material 181 can be applied to the respective sides of separator 18 using sequential, 1-sided coating techniques. For example, the cathode-compatible material 186 and the anode-compatible material 181 can be applied to the separator 18 via dip coating, knife-over-edge coating, slot die coating, direct gravure coating, micro-gravure coating, spray coating, and other techniques known by those of skill in the art.

In some embodiments, the polymeric binder of the cathode-compatible material 186 comprises the polymeric separator 18. In such embodiments, the LATP particles, LLTO particles, LAGP particles, and/or LISICON particles are embedded into the cathode side 184 of the separator 18. Additionally or alternatively, in some embodiments the polymeric binder of the anode-compatible material 181 comprises the polymeric separator 18. In such embodiments, the LLZO particles are embedded into the anode side 181 of the separator 18. In all such embodiments, the LATP particles, LLTO particles, LAGP particles, and/or LISICON particles and the LLZO particles can be coated or embedded into the cathode side 184 surface and the anode side 181 surface of the separator 18, respectively, by rolling or chemical means. For example, the separator 18 can be softened (e.g., via heating) or partially dissolved via a solvent before embedding the one or more SSE particles. In a particular example, LLZO readily passivates in the presence of certain chemicals (e.g., water and CO₂) forming a passivation layer on the outside of the LLZO particles which is sufficiently sticky to act as a binder during application of the LLZO particles to the anode side 181 of the separator 18. Separator 18 can be advantageously utilized in a lithium battery cell (e.g., cell 10) with a liquid electrolyte 17 to provide two-phase ionic conduction of lithium ions within the liquid electrolyte 17 and via the one or more of LATP particles, LLTO particles, LAGP particles, and LISICON particles and LLZO particles incorporated into the separator 18. In some embodiments, the cathode-compatible material and the anode-compatible material each comprise at most 25 wt. %, at most 30 wt. %, or at most 35 wt. % polymeric binder. In some embodiments, the one or more of LATP particles, LLTO particles, LAGP particles, and LISICON particles and the LLZO particles each have an average particle size (i.e., diameter) of about 10 nm to about 11 μm, about 50 nm to about 10 μm, or about 100 nm to about 5 μm. In some embodiments, the one or more of LATP particles, LLTO particles, LAGP particles, and LISICON particles and the LLZO particles each have an average particle size of about 5 nm to about 25 nm, about 7.5 nm to about 22.5 nm, or about 10 nm to about 20 nm. In some embodiments the cathode-compatible material 186 can have a thickness T2 of about 100 nm to about 20 μm. In some embodiments, the anode-compatible material 181 can have a thickness of about 100 nm to about 20 μm.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A separator for a lithium-ion battery comprising:
a porous polymeric separator body having an anode side and a cathode side;
a cathode-compatible material applied to the cathode side, wherein the cathode-compatible material comprises a polymeric binder and one or more of lithium aluminum titanium phosphate (LATP) particles, lithium lanthanum titanate (LLTO) particles, lithium aluminum germanium phosphate (LAGP) particles, and lithium supertonic conductor (LISICON) particles; and
an anode-compatible material applied to the anode side, wherein the anode-compatible material comprises lithium lanthanum zirconium oxide (LLZO) particles and a polymeric binder.

2. The separator of claim 1, wherein the polymeric binder of the cathode-compatible material comprises polyvinylidene fluoride (PVDF).

3. The separator of claim 1, wherein the polymeric binder of the anode-compatible material comprises polyvinylpyrrolidone (PVP).

4. The separator of claim 1, wherein the polymeric binder of the cathode-compatible material comprises the polymeric separator and the polymeric binder of the anode-compatible material comprises the polymeric separator.

5. The separator of claim 1, wherein the cathode-compatible material and the anode-compatible material each comprise at most 30 wt. % polymeric binder.

6. The separator of claim 1, wherein the LLZO particles and the one or more of LATP particles, LLTO particles, LAGP particles, and LISICON particles each have an average particle size of about 10 nm to about 10 μm.

7. The separator of claim 1, wherein the cathode-compatible material and the anode-compatible material each have a thickness of about 100 nm to about 20 μm.

8. The separator of claim 1, wherein the separator body comprises one or more of polyethylene and polypropylene.

9. The separator of claim 1, wherein the separator body has an average porosity of about 30% to 70%.

10. The separator of claim 1, wherein the separator body has a thickness of about 7 μm to 19 μm.

11. A lithium battery cell, comprising:
an electrolyte;
an anode disposed within the electrolyte;
a cathode disposed within the electrolyte; and
a separator disposed within the electrolyte between the anode and the cathode, wherein the separator includes:
a porous polymeric separator body having an anode side and a cathode side,
a cathode-compatible material applied to the cathode side, wherein the cathode-compatible material comprises a polymeric binder and one or more of lithium aluminum titanium phosphate (LATP) particles, lithium lanthanum titanate (LLTO) particles, lithium aluminum germanium phosphate (LAGP) particles, and lithium superionic conductor (LISICON) particles, and
an anode-compatible material applied to the anode side, wherein the anode-compatible material comprises lithium lanthanum zirconium oxide (LLZO) particles and a polymeric binder.

12. The lithium battery cell of claim 11, wherein the polymeric binder of the cathode-compatible material comprises polyvinylidene fluoride (PVDF) and the polymeric binder of the anode-compatible material comprises polyvinylpyrrolidone (PVP).

13. The lithium battery cell of claim 11, wherein the electrolyte is a liquid electrolyte.

14. The lithium battery cell of claim 11, wherein the cathode-compatible material and the anode-compatible material each comprise at most 30 wt. % polymeric binder.

15. The lithium battery cell of claim 11, wherein the LLZO particles and the one or more of LATP particles, LLTO particles, LAGP particles, and LISICON particles each have an average particle size of about 10 nm to about 10 μm.

16. The lithium battery cell of claim 11, wherein the cathode-compatible material and the anode-compatible material each have a thickness of about 100 nm to about 20 μm.

17. The lithium battery cell of claim 11, wherein the cathode comprises a lithium iron phosphate active material.

18. The lithium battery cell of claim 11, wherein the cathode comprises a LiNiₓCo_{y}Mn_{z}O₂ active material, wherein 0.33<x<0.85, 0.05<y<0.33, 0.05<z<0.33, and x+y+z=1.

19. The lithium battery cell of claim 11, wherein the cathode comprises a Li_{1.2}Mn_{0.525}Ni_{0.175}Co_{0.1}O₂ active material.

20. The lithium battery cell of claim 11, wherein the cathode comprises a LiNiₐCo_{b}Mn_{c}Al_{d}O₂ active material, wherein 0.33<a<0.9, 0.05<b<0.33, 0.05<c<0.33, 0.01<d<0.02, a+b+c+d=1.
